(19) United States
(12) Patent Application Publication
(10) Pub. No.: US 2005/0073666 A1
(43) Pub. Date: Apr. 7, 2005

(54) Illumination optical system and exposure apparatus having the same

(76) Inventor: Kanjo Orino, Tokyo (JP)

Correspondence Address: MORGAN & FINNEGAN, L.L.P., 3 WORLD FINANCIAL CENTER, NEW YORK, NY, 10281-2101, US

(21) Appl. No.: 10/955,884

(22) Filed: Sep. 30, 2004

(30) Foreign Application Priority Data
Oct. 6, 2003 (JP) 2003-347167

(51) Int. Cl. G03B 27/54

(52) U.S. Cl. 355/67; 355/53

(57) ABSTRACT

An illumination optical system for illuminating an object surface using light from a light source includes a condenser optical system for directing the light from the light source to the object surface, wherein the condenser optical system includes first and second optical systems, one of which forms a beam expander optical system for varying a diameter of incident light, the beam expander being adapted to be movable as one element along an optical axis.

### BACKGROUND OF THE INVENTION

The present invention relates generally to an illumination optical system and an exposure apparatus using the same, and more particularly to an illumination optical system that includes a condenser optical system for irradiating the light from plural-light-source forming means onto an object surface, and an exposure apparatus using the same.

The conventional semiconductor device manufacturing process for forming ultra fine patterns, such as LSIs and very LSIs, has employed a reduction projection exposure apparatus that projects a reduced size of a circuit pattern on a reticle onto an object to be exposed, such as a photosensitive-agent applied silicon wafer. As the improved packaging density of the semiconductor devices requires finer circuit patterns, the exposure apparatus is required to promote the finer processing whereas the resist process is required to develop.

One measure to promote the fine processing generally is to increase a numerical aperture (“NA”), such as a NA of 0.8 or higher, but the high NA reduces a depth of focus. Accordingly, an object-side telecentric projection optical system that maintains as parallel as possible a principal ray of the light that images on the object to be exposed, is used to maintain a wider practical depth of focus for exposures of circuit patterns.

Manufacturing errors that occur in manufacturing a projection exposure apparatus, such as processing size errors of optical elements, coating errors of antireflection coatings of the optical elements and dielectric multilayer coatings of highly reflective mirrors, and assembly errors of optical systems, deteriorate the parallelism of the principal ray of the light that finally images on the object or offsets the telecentricity at the wafer side. This would cause asymmetrical incident angles of the imaging rays at the wafer side, a distorted effective light source, and uneven critical dimensions that have been exposed.

Various solution methods have been conventionally proposed. See, for example, Japanese Patent Applications, Publication Nos. 2001-155993 and 2002-184676. The former reference proposes to arrange a rod-type optical integrator in front of a condenser optical system. The latter reference includes two lens units movable in the optical-axis direction in a condenser optical system that is arranged after a fly-eye lens. This reference corrects the telecentricity using the front unit, and the focus offset by movements of the front unit using the back unit.

However, the former reference causes wide focus movements of the condenser optical system on the surface to be illuminated, and significant spot-diameter fluctuations associated with the movements of the condenser optical system. This lowers the illumination efficiency for the illuminated surface, and deteriorates the throughput in manufacturing semiconductor devices using this projection exposure apparatus. The latter reference corrects the focus movements as one problem in the former reference, but requires two movable units, disadvantageously causing a complex, large and expensive mechanism for a barrel's movable part.

### BRIEF SUMMARY OF THE INVENTION

The present invention is directed to an illumination optical system and an exposure apparatus having the same, which maintain intended throughput, easily adjust the parallelism of a principal ray of exposure light or the telecentricity at an object to be exposed for high-quality exposure.

An illumination optical system according to one aspect of the present invention for illuminating an object surface using light from a light source includes a condenser optical system for directing the light from the light source to the object surface, wherein the condenser optical system includes first and second optical systems, one of which forms a beam expander optical system for varying a diameter of incident light, the beam expander being adapted to be movable as one element along an optical axis.

A condition |f2/f1|≦2.5 is preferably met, where f1 is a focal distance of the beam expander optical system, and f2 is a focal distance of the other one of the first and second optical systems, which does not form the beam expander optical system. The illumination optical system may further include plural-light-source forming part for forming plural light sources from the light from the light sources, wherein the beam expander optical system is located at an incident side of the condenser optical system and sets an exit end of the plural-light-source forming part at an incident pupil position, and wherein a condition |f2/P1|≦1.0 is met, where P1 is an exit pupil distance of the beam expander optical system and f2 is a focal distance of the other one of the first and second optical systems, which does not form the beam expander optical system. The beam expander optical system may be located at an exit side of the condenser optical system and sets an object surface at an incident pupil position, wherein a condition |f2/P1|≦1.0 is met, where P1 is an exit pupil distance of the beam expander optical system, and f2 is a focal distance of the other one of the first and second optical systems, which does not form the beam expander optical system. A condition 1.3≦H2/H1≦1.7 or a condition 1.3≦H1/H2≦1.7 may be met, where when light parallel to the optical axis and having a maximum height of H1 from the optical axis is incident upon the beam expander optical system, the light exits the beam expander optical system with a maximum height of H2. The beam expander optical system may be located at an incident side of the condenser optical system, and include a concave lens at the incident side. The beam expander optical system may be located at an exit side of the condenser optical system, and include a concave lens at the exit side. The beam expander optical system may include a concave lens having at least one aspheric surface.

Conditions 0.97≦sin θ₂/sin θ₁≦1.03, and 0.98≦(sin θ₁+sin θ₂)/2 sin θ₀≦1.02 may be met, where θ₀ is an absolute value of an angle between an upper maximum ray of axial light incident upon the object surface and the optical axis, θ₁ is an angle between a principal ray and the upper maximum ray of the light that condenses at a maximum image point on the object surface, and θ₂ is an angle between the principal ray and a lower maximum ray. The other one of the first and second optical systems, which does not form the beam expander optical system, may include a first optical element located at an outermost side of the condenser optical system, a first barrel for holding the first optical element, a second optical element different from the first optical element, and a second barrel for holding the second optical element, the second barrel being detachably connected to the first barrel, wherein a condition 0.02≦|FA/f3|≦0.2 is met, where FA is a focal distance of the condenser optical system, and f3 is a focal distance of the first optical element.

The illumination optical system may further include a shield for defining an illuminated area having a rectangular shape on the object surface, wherein the shield includes two pairs of shielding members each of which defines a pair of parallel sides of the rectangular shape, wherein one of the two pairs of shielding parts are located at a focus position of the condenser optical system, when the beam expander optical system is located at an end of a movable range along the optical axis. The illumination optical system may further include an optical integrator having an exit end that substantially has a Fourier transform relationship with the object surface.

An absolute value of a σ distortion that is defined as (NA₂/NA−1)×100 may be smaller than 3, where NA₁ is a numerical aperture of an upper maximum ray of the light that condenses each image point on the object surface, and NA₂ is a numerical aperture of a lower maximum ray of the light that condenses each image point on the object surface. An absolute value of a local a that is defined as {(NA₁+NA₂)/2NA₀−1}×100 may be smaller than 2, where NA₀ is a numerical aperture of axial light incident upon the object surface, NA₁ is a numerical aperture of an upper maximum ray of the light that condenses each image point on the object surface, and NA₂ is a numerical aperture of a lower maximum ray of the light that condenses each image point on the object surface.

An illumination optical system according to another aspect of the present invention for illuminating an object surface using light from a light source includes a beam expander optical system for varying a diameter of incident light, and for correcting a telecentricity on the object surface, the beam expander being adapted to be movable as one element along an optical axis.

An exposure apparatus according to still another aspect of the present invention includes the above illumination optical system, and a projection optical system for projecting a pattern on a reticle onto an object to be exposed, the reticle being located on or conjugate to the object surface.

The projection optical system may have a numerical aperture of 0.8 or greater. The exposure apparatus may further include a moving mechanism for moving the beam expander optical system as one element along the optical axis, a detector for detecting a telecentricity on the object surface, a memory for storing a relationship between the telecentricity and a moving amount of the beam expander optical system, and a controller for controlling the moving amount of the beam expander optical system by the moving mechanism based on a detection result by the detector. The exposure apparatus may further include a selector for selecting one of plural types of illumination conditions, wherein the detector detects the telecentricity on the object surface after the selector selects.

An exposure apparatus according to still another aspect of the present invention includes an illumination optical system for illuminating an object surface using light from a light source, the illumination optical system comprising a condenser optical system for directing the light from the light source to the object surface, wherein the condenser optical system includes first and second optical systems, one of which forms a beam expander optical system for varying a diameter of incident light, the beam expander being adapted to be movable as one element along an optical axis, a projection optical system for projecting a pattern on a reticle onto an object to be exposed, the reticle being located on or conjugate to the object surface, and a dipole illuminating part for forming two effective light source areas on a pupil of the projection optical system, wherein the following conditions are met, where σ₁ is an inner diameter of each of two effective light source areas, σ₂ is an outer diameter of each of two effective light source areas, Ω is a polar angle between two effective light source areas and a center of the pupil as a rotating center, θ₁ is an angle between a principal ray and the upper maximum ray of the light that condenses at a maximum image point on the object surface, and θ₂ is an angle between the principal ray and a lower maximum ray 0.7≦σ₁≦1.0, 0.6≦σ₂≦0.95, 10°≦Ω≦90°, and 0.95≦sin θ₂/sin θ₁≦1.05.

A device fabrication method according to still another aspect of the present invention includes the steps of exposing an object using the above exposure apparatus, and developing the object exposed. Claims for a device fabricating method for performing operations similar to that of the above exposure apparatus cover devices as intermediate and final products. Such devices include semiconductor chips like an LSI and VLSI, CCDs, LCDs, magnetic sensors, thin film magnetic heads, and the like.

Other objects and further features of the present invention will become readily apparent from the following description of the preferred embodiments with reference to the accompanying drawings.

### BRIEF DESCRIPTION OF THE DRAWINGS

FIG. 1 shows a simplified optical path of an illumination optical system according to one embodiment of the present invention.

FIG. 2 shows a lateral aberration in a meridional direction, a lateral aberration in a sagittal direction, a σ distortion, and a local a at a first position in a condenser optical system in the illumination optical system shown in FIG. 1.

FIG. 3 shows a lateral aberration in a meridional direction, a lateral aberration in a sagittal direction, σ a distortion, and a local a at a second position in a condenser optical system in the illumination optical system shown in FIG. 1.

FIG. 4 shows a simplified optical path of an exposure apparatus according to one embodiment of the present invention.

FIG. 5 shows a simplified optical path of an exposure apparatus according to another embodiment of the present invention.

FIG. 6 is a flowchart for explaining a method for fabricating devices (semiconductor chips such as ICs, LSIs, and the like, LCDs, CCDs, etc.).

FIG. 7 is a detailed flowchart of a wafer process in Step 4 of FIG. 6.

### DETAILED DESCRIPTION OF THE PREFERRED EMBODIMENTS

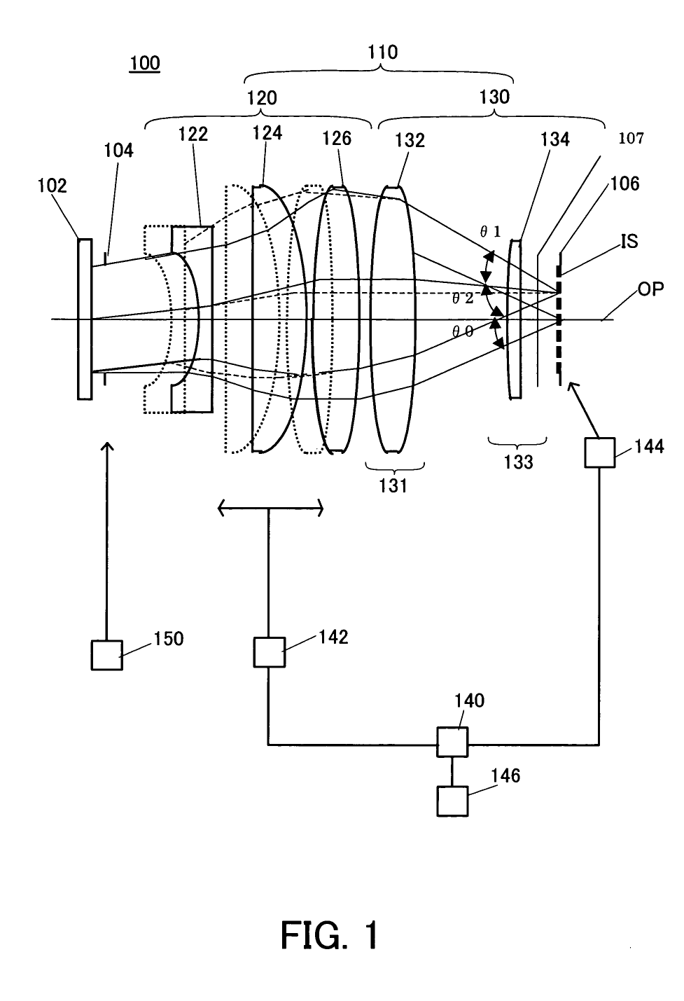

A description will be given of an illumination optical system 100 according to one embodiment of the present invention, with reference to FIG. 1. Here, FIG. 1 is shows a simplified optical path of the illumination optical system 100. The illumination optical system is part of an illumination apparatus or exposure apparatus, which further includes a controller 140, a moving mechanism 142, a detector 144, a memory 146, and an illumination condition varying section 150, in addition to the illumination optical system 100.

The illumination optical system 100 includes, as shown in FIG. 1, a secondary-light-source forming means 102, an aperture stop 104, a masking blade 106, and a condenser optical system 110, and illuminates an object surface IS using the light from a light source (not shown).

While the secondary-light-source forming means 102 is a fly-eye lens in the instant embodiment, it may be an optical rod, and another integrator or plural-light-source forming means. The aperture stop 104 is located as an incident pupil at an exit side of the secondary-light-source forming means 102. A position of the masking blade 106 is located at the object surface IS to be illuminated. Therefore, the secondary-light-source forming means 102 substantially has a Fourier transform relationship with the object surface IS. The object surface IS is located at the same surface as or a surface conjugate with a mask or reticle, which will be described later.

The condenser optical system 110 is located between the secondary-light-source forming means 102 and the masking blade 106, and serves to make the principal ray parallel to the optical axis OP (or perpendicular to the object surface IS) and to correct the telecentricity on the object surface IS.

The condenser optical system 110 includes, in order from an incident side along the optical axis, a first lens unit 120 and a second lens unit 130. Since the present invention is directed to a catoptric optical system that is broadly applicable to the EUV light, the first and second lens units 120 and 130 are broadly applied to the first and second optical systems. Since the fly-eye lens 102 substantially has a Fourier transform relationship with the object surface IS, the condenser optical system 110 can maintain the effects of the instant embodiment even if the entire system from the fly-eye lens 102 to the object surface IS is reversed. The first lens unit 120 serves to correct the telecentricity of the illumination light, and the second lens unit 130 serves to condense the light.

The first lens unit 120 includes, in order from the incident side along the optical axis, a concave lens 122, a convex lens 124, and a convex lens 126, forming a beam expander optical system. In order to vary the parallelism of the exit principal ray or the object-side telecentricity, the first lens unit 120 arranges the concave lens 122 at the incident side and the convex lenses 124 and 126 at the exit side, thereby forming the beam expander optical system that provides an incident ray diameter greater than an exit ray diameter when the first lens unit 120 receives parallel light.

The first lens unit (beam expander optical system) 120 is made movable as one member along the optical axis OP by the moving mechanism 142, which will be described later. Thus, a variation of the exit pupil position from the first lens unit 120 would change an exit pupil position of the entire condenser optical system 110 of this embodiment and the object-side telecentricity.

In order to restrain the focus variance and exit NA's fluctuations when the first lens unit 120 moves along the optical axis OP, the first lens unit 120 should meet the following Equation 1, where f1 is a focal distance of the first lens unit 120, and f2 is a focal distance of the second lens unit 130. Equation 1 is preferably Equation 2, and the instant embodiment sets a value of |f2/f1| to 1.16:
|f2/f1|≦2.5 (1)
|f2/f1|≦1.2 (2)

A value of |f2/f1| greater than 2.5 enlarges the moving amount in the optical axis OP direction and requires the second lens unit 130 to move, causing the moving mechanism 142 to be large, complex, and expensive. On the other hand, when it is equal to or smaller than 1.2, various aberrations can be properly reduced and the telecentricity can be changed effectively even when the first lens unit 120 is moved.

The following Equation 3 should be met, where P1 is an exit pupil distance of the first lens unit 120 that has the incident pupil position at the exit end of the secondary-light source means 102, in order to properly reduce various aberrations and maintain a broad range of the telecentricity even when the first lens unit 120 is moved. Equation 3 is preferably Equation 4, and this embodiment provides 0.49≦|f2/P1|≦0.65:
|f2/P1|≦1.0 (3)
0.4≦|f2/P1|≦0.8 (4)

A value of |f2/P1| greater than 1.0 causes insufficient variances of the telecentricity even when the first lens unit 120 moves because of the weak refractive power of the second lens unit 130. A range between 0.4 and 0.8 practically prevents the variance of the telecentricity from being too insensitive and too sensitive when the first lens unit 120 is moved. As discussed, since the first and second lens units 120 and 130 can be replaced with each other, Equations 3 and 4 are met when the beam expander optical system is located at the exit side of the condenser optical system 110, where P1 is the exit pupil distance of the beam expander optical system that has the incident pupil position at the object surface IS, and f2 is the focal distance of the second lens unit 130.

The object-side telecentricity of the condenser optical system 110 is made variable with the first lens unit 120 that meets H2/H1=1.5 relative to the incident parallel light to the optical axis OP, where Hi is a height of the incident light in the first lens unit 120 from the optical axis, and H2 is a height of the exit light in the first lens unit 120 from the optical axis OP. In order to reduce various aberrations and maintain a wide variable range of the object-side telecentricity, the following Equation 5 should be met with respect to the height H1 of the incident light and the height H2 of the exit light:
1.3≦H2/H1≦1.7 or 1.3≦H1/H2≦1.7 (5)

H2/H1 or H1/H2 smaller than 1.3 provides the telecentricity with the improperly insensitive variability when the first lens unit 120 moves, since the incident height of the principal ray upon the second lens unit 130 is too low. H2/H1 or H1/H2 greater than 1.7 provides the telecentricity with the excessively sensitive variability when the first lens unit 120 moves, since the incident height of the principal ray upon the second lens unit 130 is too high.

In order to enlarge this light diameter difference for the larger variance of the telecentricity, the power of the concave lens 122 should be made greater. Therefore, the divergent angle of the exit light from the concave lens 122 should be large. For proper corrections of the various aberrations, the curvature of the incident surface of the concave lens 122 should be made stronger and the curvature of its exit surface should be made weaker. This embodiment uses an aspheric surface for the concave lens 122 in the first lens unit 120 so as to vary the object-side telecentricity, and make an aspheric exit side that has a curvature low enough to form an aspheric shape.

The second lens unit 130 includes a convex lens 132 and a convex lens 134 through a relatively wide space. The convex lens 132 is housed in a lens barrel 131, while the convex lens 134 is housed in a lens barrel 133.

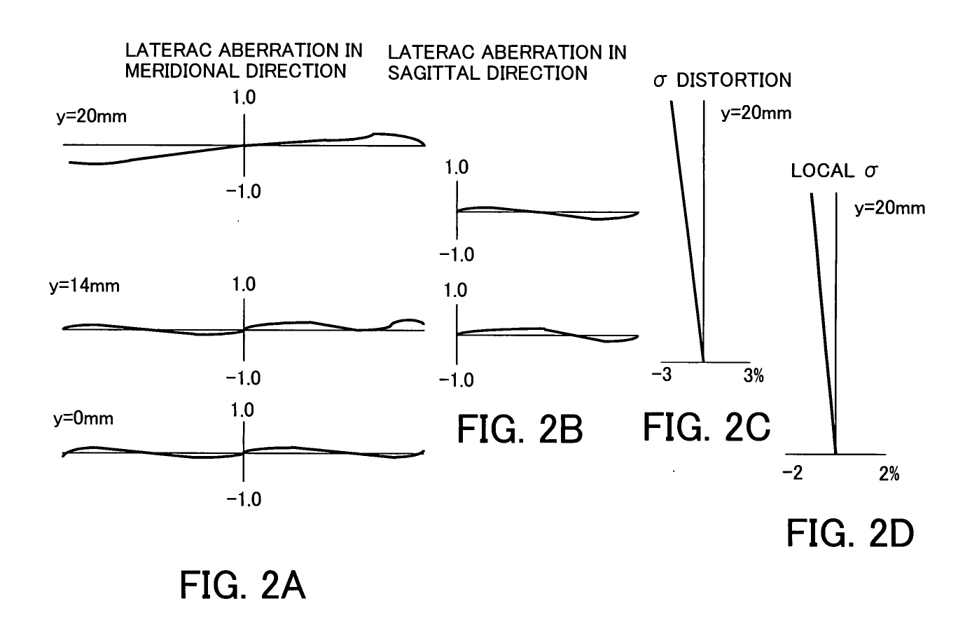

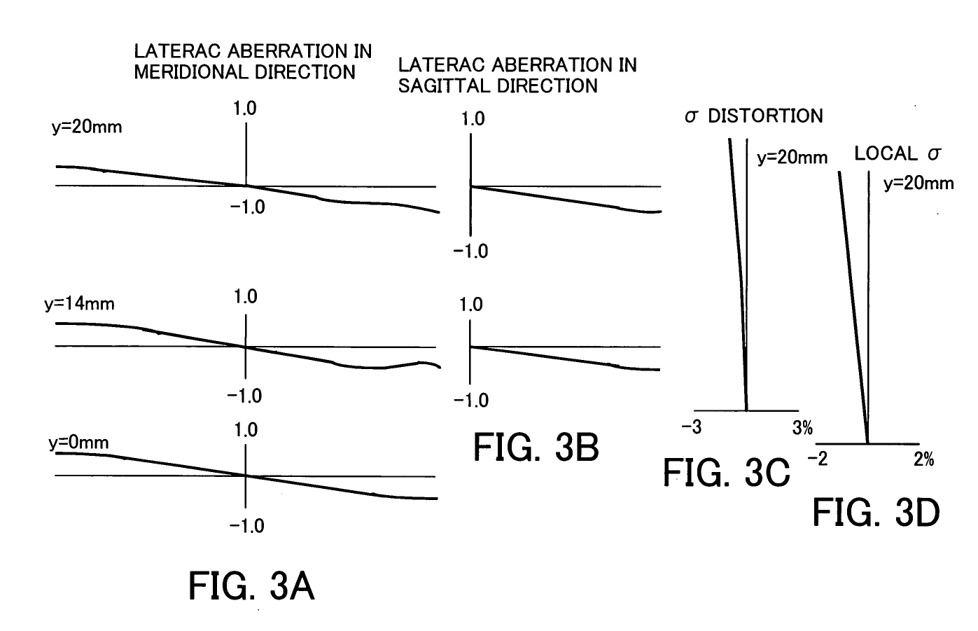

FIGS. 2 and 3 show aberrational diagrams at states where the first lens unit 120 and the second lens unit 130 are located closest to each other and separated farthest from each other. More specifically, FIG. 2A shows a lateral aberration in a meridional direction at a first position P₁ of the condenser optical system 110. FIG. 2B shows a lateral aberration in a sagittal direction. FIG. 2C shows a σ distortion. FIG. 2D shows a local σ. FIG. 3A shows a lateral aberration in a meridional direction at a second position P₂ of the condenser optical system 110. FIG. 3B shows a lateral aberration in a sagittal direction. FIG. 3C shows a σ distortion. FIG. 3D shows a local σ. The aberrational diagram indicates a lateral aberration and σ performance as major performance indexes. Here, the σ performance is a performance index for evaluating properness on the illuminating light on the object surface IS, and is expressed by the a distortion and local σ. The σ distortion and local σ are expressed by the following equations, where NA₀ is a NA of axial light incident upon the object surface IS, NA₁ is a NA of an upper maximum ray of the light that condenses each image point on the object surface IS, and NA₂ is a numerical aperture of a lower maximum ray of the light that condenses each image point on the object surface IS:
σ distortion=(NA₂/NA₁−1)×100 [unit: %] (6)
local σ={(NA₁+NA₂)/2NA₀−1}×100 [unit: %] (7)

In the projection exposure apparatus, the deteriorated σ distortion causes asymmetry of the exposed patterns between each image point on the exposed object, whereas the deteriorated local σ causes scattering sizes of the exposed pattern among image points on the exposed object. In order to maintain the size errors of the exposed pattern on the object within the practically permissible level, the σ distortion should be 3% or smaller and local σ should be 2% or smaller.

The instant embodiment has such a performance that the σ distortion has a maximum value of 2.5% at the maximum image point at the position P₁, and the local a has a maximum value of 1.3% at the maximum image point at the position P₁. The condenser optical system of the instant embodiment meets the permissible level of the projection exposure apparatus that seeks for the fine processing of the circuit pattern.

Table 1 shows a specification of the condenser optical system 110, where f1 is the focal distance of the first lens unit 120, f2 is the focal distance of the second lens unit 130, f3 is the focal distance of a final lens 134 in the condenser optical system 110, and FA is a focal distance between both ends along the optical axis OP when the first lens unit 120 moves in condenser optical system 110 of this embodiment:

TABLE 1
SPECIFICATION OF RE-IMAGING OPTICAL SYSTEM
USED FOR EMBODIMENT OF THE PRESENT INVENTION
λ = 0.193 μm, APERTURE-STOP DIAMETER = 100 mm,
MAXIMUM IMAGE POINT = 20 mm

| | r | d | n | NOTES |
|---|---|---|---|---|
| 1: | ∞ | d1: | 1 | APERTURE |
| | | VARIABLE | | STOP |
| 2: | −110.88695 | 6.3 | 1.560248 | 122 |
| *3: | 1251.28760 | 41.1 | 1 | |
| 4: | 4781.33767 | 46.5 | 1.560248 | 124 |
| 5: | −145.36814 | 13.3 | 1 | |
| 6: | 399.51554 | 37.0 | 1.560248 | 126 |
| 7: | −399.51554 | d7: | 1 | |
| | | VARIABLE | | |
| *8: | 319.13142 | 37.5 | 1.560248 | 132 |
| 9: | −375.17503 | 101.3 | 1 | 134 |
| 10: | 1818.23930 | 5.6 | 1.560248 | |
| 11: | ∞ | 42.2 | 1 | |
| EVALUATION: | ∞ | | | |
| PLANE | | | | |

*SURFACE IS ASPHERIC SURFACE

| ASPHERIC COEFFICIENTS | ASPHERIC COEFFICIENTS |
|---|---|
| FOR THREE SURFACES | FOR THREE SURFACES |
| K = −1.5 | K = −0.226389 |
| A = +2.82370 × 10⁻⁷ | A = −4.54215 × 10⁻⁸ |
| B = −1.63956 × 10⁻¹⁰ | B = +1.03037 × 10⁻¹¹ |
| C = +1.07552 × 10⁻¹³ | C = −2.10279 × 10⁻¹⁵ |
| D = −3.61647 × 10⁻¹⁷ | D = +2.21972 × 10⁻¹⁹ |
| E = +6.08217 × 10⁻²¹ | E = −1.14313 × 10⁻²³ |
| F = −4.13907 × 10⁻²⁵ | F = +2.12935 × 10⁻²⁸ |

SPECIFICATION AT EACH POSITION

| POSITIONS | Z 1 | Z 2 | |
|---|---|---|---|
| F A | 122.9 | 125.4 | FOCAL DISTANCES OF |
| d 1 | 46.72 | 34.40 | UNITS AND FINAL LENS |
| d 7 | 7.51 | 19.83 | f1 = +254.2 mm |
| P 1 | −603.7 | −458.4 | f2 = +295.7 mm |
| P A | +401.4 | +570.4 | f3 = +3245.4 mm |
| | | | HEIGHTS OF INCIDENT |
| | | | LIGHT AND EXIT LIGHT |
| | | | FOR INCIDENT PARALLEL |
| | | | LIGHT |
| | | | H 1 = 50 mm |
| | | | H 2 = 75.2 mm |

VALUES OF VARIOUS EQUATIONS RELATING TO CLAIMS

f2/f1 = 1.16
0.49 ≦ | f2/P 1 | ≦ 0.65
H 2/H 1 = 1.50
0.038 ≦ | F A/f3 | ≦ 0.039

In Table 1, P₁ is an exit pupil distance at the first lens unit 120 when the aperture stop 104 is set as the incident pupil. PA is an exit pupil distance of the entire condenser optical system 110 when the aperture stop 104 is set as the incident pupil.

In Table 1 as a lens data table, r is a radius of curvature for each surface (unit: mm), d is a surface separation (unit: mm), and n is a refractive index of a medium relative to incident light (with a wavelength of 0.193 μm). Various coefficients relating to an aspheric surface in Table 1 is given by the following Equation 8, where h is a height in a direction perpendicular to the optical axis at an arbitrary point on the aspheric surface, x is a distance along the optical axis direction, r is a radius of curvature at the apex, and K is a curvature coefficient, and A to K are aspheric coefficients:
x=h²/r/[1+{1−(1+K)(h/r)²}^{1/2}]+Ah⁴+Bh⁶+Ch⁸+Dh¹⁰+Eh¹²+Fh¹⁴ (8)

According to the thus configured optical system, the instant embodiment according to the present invention uses an optical system that can properly reduce the image-point performance of the σ distortion and maintain a wider variable range of the object-side telecentricity using the smaller number of lenses.

The instant embodiment sets the focal distance FA of the condenser optical system 110 to 122.9 mm≦FA≦125.4 mm, and the focal distance f3 of the convex lens G105 as a minimum lens to 3245.4 mm. Therefore, 0.038≦FA/f3≦0.039 is met. The power of the convex lens G134 is smaller than that of the condenser optical system, and the decentering sensitivity of this lens is small. Therefore, even when the deteriorated convex lens G134 is exchanged with a new one or with a lens that has slightly different power, a variable range of the exit pupil position of the original condenser optical system can be shifted without aggravating other aberrations. The following Equation 9 should be met for such exchanges of parts. The instant embodiment enables the lens barrel 131 to be detachably connected to the lens barrel 132:
0.02≦|FA/f3|≦0.2 (13)

When a value of |FA/f3| is smaller than 0.02, the curvature of the concave lens G134 is too flat to be produced. When it exceeds 0.2, the decentering sensitivity when the convex lens G134 is exchanged becomes too strong, and the reproducibility of the optical performance deteriorates.

In general, the reticle and the object to be exposed have rectangular illumination areas in the exposure apparatus. Two pairs of shielding members for restricting the illumination area in orthogonal two directions within a section orthogonal to the optical axis OP are needed to restrict the illumination area of the object surface IS to a rectangular shape within a plane perpendicular to the optical axis OP. This embodiment assigns one pair to the masking blade 106 and the other pair to the scan blade 107, so as to use two pairs of shielding members as shielding means for determining an illumination area of the object surface 104. Then, the focus is moved slightly by moving the movable unit so that a light shielding position of the masking blade 106 is located near the focus position for the position P₁ when the first lens unit as a movable unit is located closest to the second lens unit as a fixed unit. Moreover, a light shielding position of the scan blade 107 is located near the focus position for the position P₂ when the first lens unit is located most distant from the second lens unit. Thereby, the condenser optical system 110 has the high irradiation energy efficiency of the irradiation light upon the object surface IS using the movements of the movable unit.

The masking blade 106, located optically conjugate with the object surface, is a stop that can automatically vary an aperture width or a length of the rectangular slit area in a longitudinal direction. The scan blade is also a stop that can automatically vary an aperture width, and has the same structure as the masking blade. Use of these two variable blades can set a size of a transfer area in accordance with an exposure shot size.

The moving mechanism 142 is connected to the lens barrel that houses the first lens unit 120, and includes a uniaxial linear motor, etc. for moving the beam expander optical system as one member in the optical axis OP direction. The detector 144 detects the telecentricity on the object surface IS using a pinhole and an illuminance meter. The memory 146 stores a relationship between the telecentricity and the moving amount of the beam expander optical system 120. This relationship can be expressed as a table, a simulation result, an equation, etc. The controller 146 controls the moving amount of the beam expander optical system 120 by the moving mechanism 142 based on the detection result by the detector 144.

The illumination-condition varying section 150 varies illumination conditions, such as an effective-light source shape (such as a circle, a dipole, and a quadrupole), σ, and an insertion/removal of a prism, for example, by providing plural types of stops on the turret and by rotating the turret. After the illumination-condition varying section 150 determines an illumination mode, the controller 146 determines a moving amount of the beam expander optical system 120.

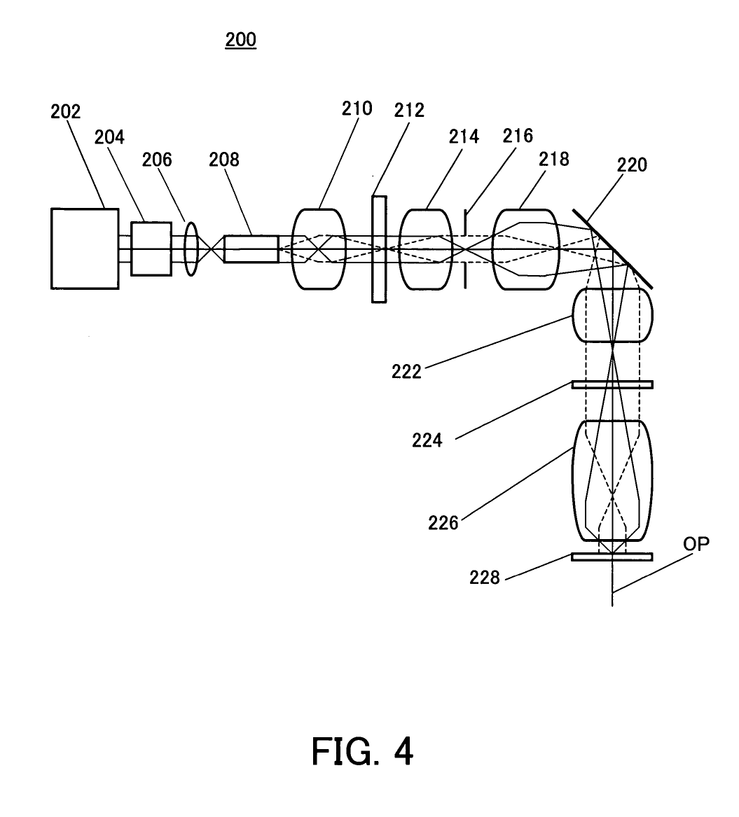

Referring now to FIG. 4, a description will be given of an exemplary exposure apparatus 200 that can apply the present invention. Here, FIG. 4 shows a simplified optical path of an exposure apparatus 200. The exposure apparatus 200 includes an illumination apparatus for illuminating a reticle (or mask) 224 which has a circuit pattern, and a projection optical system 226 for projecting the illuminated circuit pattern onto a plate 228.

The exposure apparatus 200 is a projection exposure apparatus that exposes onto the plate 228 a circuit pattern created on the mask 224, e.g., in a step-and-repeat or a step-and-scan manner. Such an exposure apparatus is suitable for a sub-micron or quarter-micron lithography process. This embodiment exemplarily describes a step-and-scan exposure apparatus (which is also called “a scanner”).

The illumination apparatus illuminates the mask 224 that has a circuit pattern to be transferred, and includes a light source unit and an illumination optical system, to which the illumination optical system 100 shown in FIG. 1 etc. is applicable.

As an example, the light source unit uses laser for a light source 202 such as an ArF excimer laser with a wavelength of approximately 193 nm, a KrF excimer laser with a wavelength of approximately 248 nm and a F₂ laser with a wavelength of approximately 157 nm. However, the laser type is not limited. A beam shaping optical system 204 for shaping parallel light from the light source into a desired beam shape, and a relay optical system 206 are provided.

The illumination optical system is an optical system that illuminates the mask 224, and includes, a pillar glass 208 with a hexagonal section, a continuously a variable optical system 210, a fly-eye lens 212, a masking blade irradiation optical system 214, an masking blade 216, a first optical system 218, a deflection mirror 220, and a second optical system 222.

The pillar glass 208 forms plural light sources from one light source using multiple reflections on inner surfaces of the glass. The light from the pillar glass 208 is incident upon the fly-eye lens 212 by the continuously a variable optical system 210. The light from the fly-eye lens 214 is incident upon the masking blade 216 by the masking blade irradiation optical system 214. The condenser optical system 110 shown in FIG. 1 can be replaced with the masking blade irradiation optical system 214. The light from the masking blade 216 irradiates the surface of the reticle 224 at the side of the circuit pattern by the mask imaging optical system (including elements 218-222).

The mask imaging optical system includes the first optical system 218, the mirror 222 that bends the optical axis OP by a right angle, and the second optical system 222.

The mask 222 forms a circuit pattern (or an image) to be transferred, and is supported and driven by a reticle stage (not shown). Diffracted light emitted from the mask 222 passes through the projection optical system 226 and is then projected onto the plate 228. The plate 228, such as a wafer and a LCD, is an exemplary object to be exposed. A photoresist is applied onto the plate 228. The reticle 224 and the plate 228 are located in an optically conjugate relationship. The scanner scans the reticle 224 and the plate 228, and transfers the pattern on the mask 224 onto the plate 228. In case of a stepper, the mask 224 and the plate 228 remain still during exposure.

The projection optical system 226 may use an optical system comprising solely of a plurality of lens elements, an optical system including a plurality of lens elements and at least one mirror (a catadioptric optical system), an optical system including a plurality of lens elements and at least one diffractive optical element such as a kinoform, a full mirror type optical system, and so on. Any necessary correction of the chromatic aberration may be accomplished by using a plurality of lens units made from glass materials having different dispersion values (Abbe values) or arranging a diffractive optical element such that it disperses light in a direction opposite to that of the lens unit.

In exposure, the light is emitted from the light source unit 202, e.g., Koehler-illuminates the mask 224 via the illumination optical system. The light that passes through the mask 224 and reflects the mask pattern is imaged onto the plate 228 by the projection optical system 226. In that case, the masking blade irradiation optical system 214 applied to the condenser optical system 110 in the illumination optical system 100 shown in FIG. 1 maintains the intended telecentricity and provides high-quality exposure to the plate 228 at a high NA. In addition, the instant structure is simpler than that of Japanese Patent Application No. 2002-184676, because only the first lens unit 120 moves in FIG. 1, and the second lens unit 130 does not have to move. Since the second lens unit 130 prevents fluctuations of a spot diameter associated with movements of the condenser optical system, and thus maintains the irradiation efficiency, providing devices with high throughput and economic efficiency, such as a semiconductor device, an LCD device, an image-pickup device (such as a CCD), and a thin-film magnetic head.

The projection exposure apparatus 200 shown in FIG. 4 uses a mask imaging optical system (218 to 222) having twice imaging magnification, and has the imaging magnification of 1/4 between the reticle 224 and the plate 228, and the maximum σ value of 0.95, which indicates a ratio between the NA of the projection optical system 226 to the NA of the illumination optical system. When the condenser optical system 110 of the instant embodiment is applied to the projection exposure apparatus having the imaging NA of 0.84 at the plate 228 side since the exit-side NA is 0.40. By applying such configured condenser optical system 110 to the masking blade irradiation optical system 214, the projection exposure apparatus 200A that can properly correct the offset telecentricity at the wafer side caused by the manufacturing errors of each optical element and assembly errors of the optical unit, using the smaller number of lenses and a simpler structure.

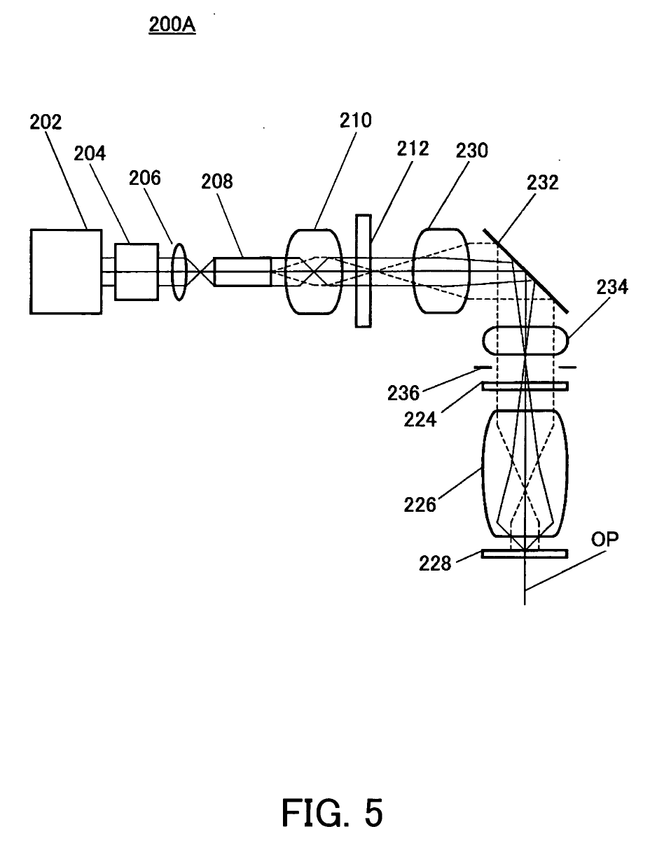

The condenser optical system 110 of the present invention is also applicable, for example, to a projection exposure apparatus 200A of a step-and-scan manner shown in FIG. 5. Here, FIG. 5 shows a simplified optical path of the exposure apparatus 200A. Those elements in FIG. 5, which are corresponding elements in FIG. 4, are designated by the same reference numeral, and a detailed description thereof will be omitted. The condenser optical system 110 shown in FIG. 1 is applicable to the reticle irradiation optical system in FIG. 5.

The reticle irradiation optical system 230 to 234 irradiates the light from the fly-eye lens 212 onto the circuit pattern surface of the reticle 224. The projection optical system 226 projects the light from the circuit pattern surface of the reticle onto the plate 228 at a reduced size, onto which reticle 224 a photosensitive material is applied. Here, the reticle irradiation optical system includes a first optical system 230, a deflection mirror 232 for bending the optical axis OP direction by the right angle, and a second optical system 234. The condenser optical system 110 is applied to this reticle irradiation optical system. In other words, the first optical system 230 is assigned to one that includes the concave lens 122 to the convex lens 132, and the second optical system 234 is assigned to the concave lens 134. The masking blade 236 for eliminating the irradiation light outside the effective irradiation area is arranged at the exit side of the condenser optical system 110.

The projection exposure apparatus 200A shown in FIG. 5 has the imaging magnification of 1/4 between the reticle 224 and the plate 228, and the maximum a value of 0.95, which indicates a ratio between the NA of the projection optical system 226 to the NA of the illumination optical system. When the aperture stop diameter of the condenser optical system 110 is 50 mm and the condenser optical system 110 is applied to the reticle illumination optical system 230 to 234 shown in FIG. 5, the projection exposure apparatus having the imaging NA of 0.84 at the plate 228 side since the exit-side NA is 0.20. By applying such configured condenser optical system 110 as the reticle irradiation optical system to the illumination apparatus, the projection exposure apparatus 200A that can properly correct the offset telecentricity at the wafer side caused by the manufacturing errors of each optical unit, using the smaller number of lenses and a simpler structure.

Use of so-called dipole illuminating means for forming two effective light source areas that are axially symmetric to each other on the pupil plane in the projection optical system 226 with the illumination optical system 100 of the instant embodiment is effective to reduction projection exposure for the finer reticle pattern.

In this case, two effective light source areas are formed symmetrically with respect to a long axis or a short axis of the rectangular irradiation shape on the plate 228. This becomes an effective light source state particularly effective to the fine processing of a critical dimension of a linear pattern that is perpendicular to a direction that connects centers of two effective light source area, if 0.7≦σ₁≦1.0, 0.6≦σ₂≦0.95, and 10°≦Ω≦90° are met where σ₁ is an inner diameter of each of two effective light source areas, σ₂ is an outer diameter of each of two effective light source areas, and Ω is a polar angle between two effective light source areas and a center of the pupil as a rotating center.

In addition, the linear pattern on the reticle can be exposed over the illuminated surface on the photosensitive substrate with a uniform critical dimension of a practically permissible level by satisfying the condition 0.95≦sin θ₂/sin θ₁≦1.05, where θ₁ is an angle between a principal ray and the upper maximum ray of the light that condenses at a maximum image point on the object surface, and θ₂ is an angle between the principal ray and a lower maximum ray.

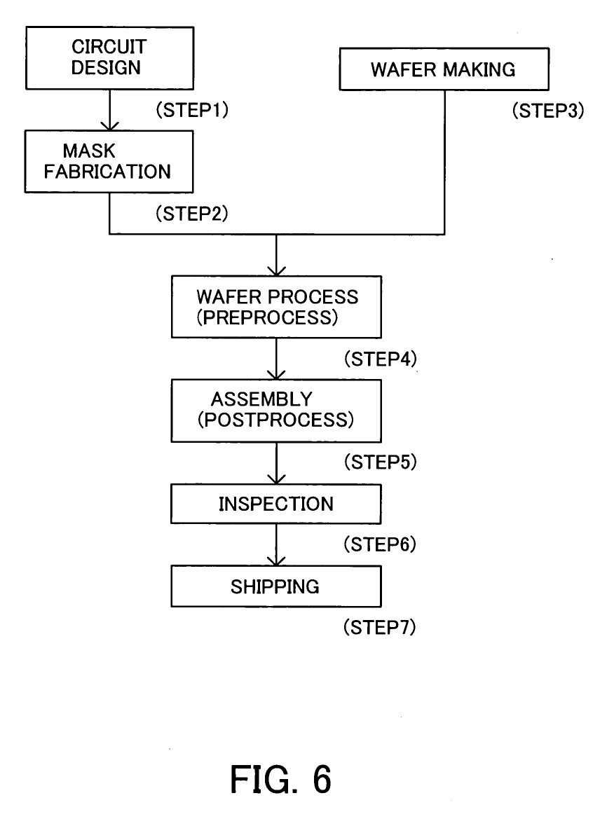

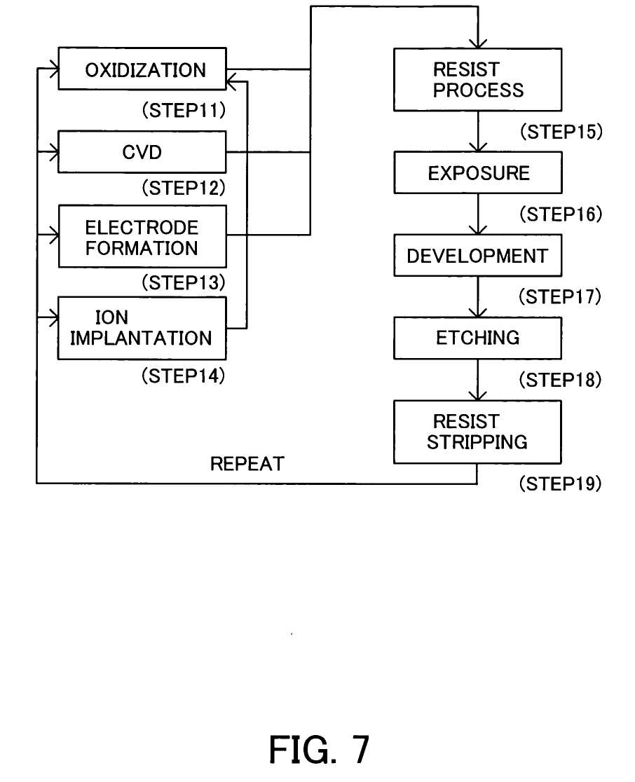

Referring now to FIGS. 6 and 7, a description will be given of a device fabrication method using the above mentioned exposure apparatuses 200 and 200A. FIG. 6 is a flowchart for explaining how to fabricate devices (i.e., semiconductor chips such as IC and LSI, LCDs, CCDs, and the like). Here, a description will be given of the fabrication of a semiconductor chip as an example. Step 1 (circuit design) designs a semiconductor device circuit. Step 2 (mask fabrication) forms a mask having a designed circuit pattern. Step 3 (wafer making) manufactures a wafer using materials such as silicon. Step 4 (wafer process), which is also referred to as a pretreatment, forms the actual circuitry on the wafer through lithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests on the semiconductor device made in Step 5, such as a validity test and a durability test. Through these steps, a semiconductor device is finished and shipped (Step 7).

FIG. 7 is a detailed flowchart of the wafer process in Step 4. Step 11 (oxidation) oxidizes the wafer's surface. Step 12 (CVD) forms an insulating layer on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatuses 200 and 200A to expose a circuit pattern from the mask onto the wafer. Step 17 (development) develops the exposed wafer. Step 18 (etching) etches parts other than a developed resist image. Step 19 (resist stripping) removes unused resist after etching. These steps are repeated to form multi-layer circuit patterns on the wafer. The fabrication method of the instant embodiment can obtain the desired telecentricity using the condenser optical system 110, and can fabricate higher-quality devices (having a desired critical dimension). Thus, the device fabrication method using the exposure apparatus, and resultant devices constitute one aspect of the present invention.

Furthermore, the present invention is not limited to these preferred embodiments and various variations and modifications may be made without departing from the scope of the present invention. Software (program) and hardware for executing the inventive telecentricity correction method, and a memory that stores the program also constitute one aspect of the present invention.

This application claims foreign priority benefits under 35 U.S.C. §119, based on Japanese Patent Application No. 2003-347167, filed on Oct. 6, 2003, which is hereby incorporated by reference herein in its entirety as if fully set forth herein.

1. An illumination optical system for illuminating an object surface using light from a light source, said illumination optical system comprising a condenser optical system for directing the light from the light source to the object surface,
wherein said condenser optical system includes first and second optical systems, one of which forms a beam expander optical system for varying a diameter of incident light, the beam expander optical system being adapted to be movable as one element along an optical axis.

2. An illumination optical system according to claim 1, wherein a condition |f2/f1|≦2.5 is met, where f1 is a focal distance of said beam expander optical system, and f2 is a focal distance of the other one of the first and second optical systems, which does not form said beam expander optical system.

3. An illumination optical system according to claim 1, further comprising plural-light-source forming part for forming plural light sources from the light from the light sources,
wherein said beam expander optical system is located at an incident side of said condenser optical system and sets an exit end of said plural-light-source forming part at an incident pupil position, and
wherein a condition |f2/P1|≦1.0 is met, where P1 is an exit pupil distance of said beam expander optical system and f2 is a focal distance of the other one of the first and second optical systems, which does not form said beam expander optical system.

4. An illumination optical system according to claim 1, wherein said beam expander optical system is located at an exit side of said condenser optical system and sets an object surface at an incident pupil position, and
wherein a condition |f2/P1|≦1.0 is met, where P1 is an exit pupil distance of said beam expander optical system, and f2 is a focal distance of the other one of the first and second optical systems, which does not form said beam expander optical system.

5. An illumination optical system according to claim 1, wherein a condition 1.3≦H2/H1≦1.7 or a condition 1.3≦H1/H2≦1.7 is met, where when light parallel to the optical axis and having a maximum height of H1 from the optical axis is incident upon said beam expander optical system, the light exits said beam expander optical system with a maximum height of H2.

6. An illumination optical system according to claim 1, wherein said beam expander optical system is located at an incident side of said condenser optical system, and includes a concave lens at the incident side.

7. An illumination optical system according to claim 1, wherein said beam expander optical system is located at an exit side of said condenser optical system, and includes a concave lens at the exit side.

8. An illumination optical system according to claim 1, wherein said beam expander optical system includes a concave lens having at least one aspheric surface.

9. An illumination optical system according to claim 1, wherein conditions:
0.97≦sin θ₂/sin θ₁≦1.03; and
0.98≦(sin θ₁+sin θ₂)/2 sin θ₀≦1.02
are met, where θ₀ is an absolute value of an angle between an upper maximum ray of axial light incident upon the object surface and the optical axis, θ₁ is an angle between a principal ray and the upper maximum ray of the light that condenses at a maximum image point on the object surface, and θ₂ is an angle between the principal ray and a lower maximum ray.

10. An illumination optical system according to claim 1, wherein the other one of the first and second optical systems, which does not form said beam expander optical system, includes:
a first optical element located at an outermost side of said condenser optical system;
a first barrel for holding the first optical element;
a second optical element different from the first optical element; and
a second barrel for holding the second optical element, said second barrel being detachably connected to said first barrel,
wherein a condition 0.02≦|FA/f3|≦0.2 is met, where FA is a focal distance of said condenser optical system, and f3 is a focal distance of the first optical element.

11. An illumination optical system according to claim 1, further comprising a shield for defining an illuminated area having a rectangular shape on the object surface,
wherein said shield includes two pairs of shielding members each of which defines a pair of parallel sides of the rectangular shape,
wherein one of the two pairs of shielding parts are located at a focus position of said condenser optical system, when said beam expander optical system is located at an end of a movable range along the optical axis.

12. An illumination optical system according to claim 1, further comprising an optical integrator having an exit end that substantially has a Fourier transform relationship with the object surface.

13. An illumination optical system according to claim 1, wherein an absolute value of a σ distortion that is defined as (NA₂/NA₁−1)×100 is smaller than 3, where NA₂ is a numerical aperture of an upper maximum ray of the light that condenses each image point on the object surface, and NA₂ is a numerical aperture of a lower maximum ray of the light that condenses each image point on the object surface.

14. An illumination optical system according to claim 1, wherein an absolute value of a local σ that is defined as {(NA₁+NA₂)/2NA₀−1}×100 is smaller than 2, where NA₀ is a numerical aperture of axial light incident upon the object surface, NA₁ is a numerical aperture of an upper maximum ray of the light that condenses each image point on the object surface, and NA₂ is a numerical aperture of a lower maximum ray of the light that condenses each image point on the object surface.

15. An illumination optical system for illuminating an object surface using light from a light source, said illumination optical system comprising a beam expander optical system for varying a diameter of incident light, and for correcting a telecentricity on the object surface, said beam expander being adapted to be movable as one element along an optical axis.

16. An exposure apparatus comprising:
an illumination optical system for illuminating a reticle using light from a light source, said illumination optical system comprising a condenser optical system for directing the light from the light source to the reticle, wherein said condenser optical system includes first and second optical systems, one of which forms a beam expander optical system for varying a diameter of incident light, the beam expander optical system being adapted to be movable as one element along an optical axis; and
a projection optical system for projecting a pattern of the reticle onto an object to be exposed.

17. An exposure apparatus according to claim 16, wherein said projection optical system has a numerical aperture of 0.8 or greater.

18. An exposure apparatus according to claim 16, further comprising:
a moving mechanism for moving said beam expander optical system as one element along the optical axis;
a detector for detecting a telecentricity on the reticle;
a memory for storing a relationship between the telecentricity and a moving amount of said beam expander optical system; and
a controller for controlling the moving amount of said beam expander optical system by said moving mechanism based on a detection result by said detector.

19. An exposure apparatus according to claim 16, further comprising a selector for selecting one of plural types of illumination conditions,
wherein said detector detects the telecentricity on the object surface after the selector selects.

20. An exposure apparatus comprising:
an illumination optical system for illuminating a reticle using light from a light source, said illumination optical system comprising a condenser optical system for directing the light from the light source to the reticle, wherein said condenser optical system includes first and second optical systems, one of which forms a beam expander optical system for varying a diameter of incident light, the beam expander optical system being adapted to be movable as one element along an optical axis;
a projection optical system for projecting a pattern of the reticle onto an object to be exposed; and
a dipole illuminating part for forming two effective light source areas on a pupil of said projection optical system,
wherein the following conditions are met, where σ₁ is an inner diameter of each of two effective light source areas, σ₂ is an outer diameter of each of two effective light source areas, Ω is a polar angle between two effective light source areas and a center of the pupil as a rotating center, θ₁ is an angle between a principal ray and the upper maximum ray of the light that condenses at a maximum image point on the object surface, and θ₂ is an angle between the principal ray and a lower maximum ray:
0.7≦σ₁≦1.0;
0.6≦σ₂≦0.95;
10°≦Ω≦90°; and
0.95≦sin θ₂/sin θ₁≦1.05.

21. A device fabrication method comprising the steps of:
exposing an object using an exposure apparatus; and
developing the object exposed,
wherein the exposure apparatus includes:
an illumination optical system for illuminating a reticle using light from a light source, said illumination optical system comprising a condenser optical system for directing the light from the light source to the reticle, wherein said condenser optical system includes first and second optical systems, one of which forms a beam expander optical system for varying a diameter of incident light, the beam expander optical system being adapted to be movable as one element along an optical axis; and
a projection optical system for projecting a pattern of the reticle onto an object to be exposed.

22. A device fabrication method comprising the steps of:
exposing an object using an exposure apparatus; and
developing the object exposed,
wherein the exposure apparatus includes:
an illumination optical system for illuminating a reticle using light from a light source, said illumination optical system comprising a condenser optical system for directing the light from the light source to the reticle, wherein said condenser optical system includes first and second optical systems, one of which forms a beam expander optical system for varying a diameter of incident light, the beam expander optical system being adapted to be movable as one element along an optical axis;
a projection optical system for projecting a pattern of the reticle onto an object to be exposed; and
a dipole illuminating part for forming two effective light source areas on a pupil of said projection optical system,
wherein the following conditions are met, where σ₁ is an inner diameter of each of two effective light source areas, σ₂ is an outer diameter of each of two effective light source areas, Ω is a polar angle between two effective light source areas and a center of the pupil as a rotating center, θ₁ is an angle between a principal ray and the upper maximum ray of the light that condenses at a maximum image point on the object surface, and θ₂ is an angle between the principal ray and a lower maximum ray:
0.7≦σ₁≦1.0;
0.6≦σ₂≦0.95;
10°≦Ω≦90°; and
0.95≦sin θ₂/sin θ₁≦1.05.
